(19) United States
(12) Patent Application Publication
(10) Pub. No.: US 2019/0041695 A1
(43) Pub. Date: Feb. 7, 2019

(54) COLOR FILTER SUBSTRATE AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Haibin YIN, Beijing (CN); Sangman YUK, Beijing (CN); Jian CHEN, Beijing (CN); Wenhao TANG, Beijing (CN)

(21) Appl. No.: 15/960,863

(22) Filed: Apr. 24, 2018

(30) Foreign Application Priority Data
Aug. 2, 2017 (CN) 201710651484.X

(51) Int. Cl. G02F 1/1335

(52) U.S. Cl. CPC G02F 1/133516; G02F 1/13394; G02F 1/133512

(57) ABSTRACT

A color filter substrate and a display device are disclosed. The color filter substrate includes: a plurality of color filter units arranged in a matrix; a patterned black matrix layer, the patterned black matrix layer filling gaps between adjacent color filter units; and an overcoating covering the plurality of color filter units and the patterned black matrix layer. Specifically, the overcoating is formed by a mixture of a binder polymer, a hardener, a multi-functional monomer and a surface active agent, wherein the binder polymer has a relative molecular mass in the range of 4,000-10,000.

### CROSS REFERENCE TO RELATED APPLICATION(S)

The present application claims the priority of the Chinese patent application No. 201710651484.X filed on Aug. 2, 2017, the entire disclosure of which is incorporated herein by reference.

### TECHNICAL FIELD

The present disclosure relates to the field of display technologies, and specifically discloses a color filter substrate and a display device.

### BACKGROUND ART

In the most recent decade, liquid crystal display technologies have developed rapidly and achieved huge progress in various aspects from screen size to display quality. At present, during the manufacture of a liquid crystal display panel, liquid crystals are mostly dropped by a One Drop Filling (ODF for short) process. In this way, the time required for dropping liquid crystals can be shortened, and the production efficiency can be improved.

However, in an existing liquid crystal cell, the ODF process is a bottleneck restricting the factory capacity. Typically, in order to meet capacity requirements for a certain production line in a certain factory, it is necessary to reduce the ODF Tact Time for ADS or TN products of the production line, so as to promote the production capacity of the factory. However, during the current production, ADS products all have a higher ODF Tact Time than TN products, which is unfavorable for meeting the capacity requirements of the corresponding production line.

### SUMMARY

According to one aspect of the present disclosure, a color filter substrate is provided. Specifically, the color filter substrate comprises: a plurality of color filter units arranged in a matrix; a patterned black matrix layer, the patterned black matrix layer filling gaps between adjacent color filter units; and an overcoating covering the plurality of color filter units and the patterned black matrix layer. Furthermore, the overcoating is formed by a mixture of a binder polymer, a hardener, a multi-functional monomer and a surface active agent, wherein the binder polymer has a relative molecular mass in a range of 4,000-10,000.

According to a specific implementation, in the color filter substrate provided by an embodiment of the present disclosure, the overcoating has a thickness in a range of 1.3-1.5 μm.

According to a specific implementation, in the color filter substrate provided by an embodiment of the present disclosure, acidic substances in the binder polymer have a percentage ranging from 5% to 15% by mass.

According to a specific implementation, in the color filter substrate provided by an embodiment of the present disclosure, the binder polymer comprises an epoxy acrylate polymer.

According to a specific implementation, in the color filter substrate provided by an embodiment of the present disclosure, after being dried, the multi-functional monomer has a percentage ranging from 10% to 60% by mass in the overcoating.

According to a specific implementation, in the color filter substrate provided by an embodiment of the present disclosure, the multi-functional monomer comprises an acryloyl-based multi-functional monomer or an epoxy-based multi-functional monomer.

According to a specific implementation, in the color filter substrate provided by an embodiment of the present disclosure, the surface active agent is formed by a mixture of a silicon-based material and a fluorine-based material.

According to a specific implementation, in the color filter substrate provided by an embodiment of the present disclosure, after being dried, the surface active agent has a percentage less than 1% by mass in the overcoating.

According to a specific implementation, in the color filter substrate provided by an embodiment of the present disclosure, after being dried, the binder polymer has a percentage ranging from 15% to 80% by mass in the overcoating.

According to a specific implementation, in the color filter substrate provided by an embodiment of the present disclosure, after being dried, the hardener has a percentage ranging from 2% to 15% by mass in the overcoating.

According to a specific implementation, in the color filter substrate provided by an embodiment of the present disclosure, the hardener comprises an acid anhydride hardener.

According to a specific implementation, in the color filter substrate provided by an embodiment of the present disclosure, the acid anhydride hardener comprises any one of a carboxyl compound, a hydroxyl compound, an alicyclic compound and an aromatic compound.

According to another aspect of this disclosure, a display device is further provided. Specifically, the display device comprises: the color filter substrate according to any of the above embodiments.

### BRIEF DESCRIPTION OF DRAWINGS

FIG. 1 shows a schematic structure view for the color filter substrate according to an embodiment of the present disclosure;

FIG. 2 is a schematic view illustrating a change trend for a vacuum arrive time before and after hardenability of the overcoating in the color filter substrate is improved according to an embodiment of the present disclosure;

FIG. 3 is a schematic view illustrating a change trend for a vacuum arrive time before and after hygroscopicity of the overcoating in the color filter substrate is improved according to an embodiment of the present disclosure; and

FIG. 4 is a schematic view illustrating changes for a PH segment gap between a black matrix and an RGB layer before and after surface flatness of the overcoating in the color filter substrate is improved according to an embodiment of the present disclosure.

### DETAILED DESCRIPTION OF EMBODIMENTS

In order to render goals, features and advantages of the present disclosure to be clearer, the present disclosure will be further described below in detail with reference to the drawings and embodiments.

In an existing liquid crystal cell, the ODF process is a bottleneck restricting the factory capacity. Typically, in order to meet capacity requirements for a certain production line in a certain factory, it is necessary to reduce the ODF Tact Time for the ADS or TN products of the production line, so as to promote the production capacity of the factory. By comparing influences of various materials in the overcoating on the ODF Tact Time, the inventor has found from research that the materials in the overcoating can influence an amount of outgas of the overcoating, thereby influencing the ODF Tact Time. Specifically, see table 1 below.

TABLE 1
comparison of ODF Tact Time for TN&ADS products

| | | | Vacuum | | | | Unmatch | | |
|---|---|---|---|---|---|---|---|---|---|
| | | Upper | | Keep | | Chamber | Check | | |
| Type | Product | Load | Arrive | Time | Press | Vent | UV | Unload | TT |
| TN | 15.6/20.7 | 17.2 | 16.8 | 1 Pa/0 s | 18.4 | 18.7 | 6.4 | 24.2 | 56 |
| | | | | | | | 5.3 | | |
| ADS | 23.6/23.8/49 | 17.2 | 33.5~38.5 | 0.5 Pa/15~18 s | 15.8 | 16.25 | 6.4 | 18 | 62 |
| (1.3 μm) | | | | | | | 5.3 | | |

By comparing the ODF Tact Time for the TN products and ADS products, it can be found that the overcoating in the color filter substrate has a fundamental influence on the ODF Tact Time. Specifically, the amount of outgas of the overcoating is a key factor influencing the ODF Tact Time.

To this end, materials in the overcoating can be improved in order to reduce the amount of outgas of the overcoating, thereby reducing the ODF Tact Time and promoting the production capacity of the factory. Specifically, this will be explained in detail in the embodiments below.

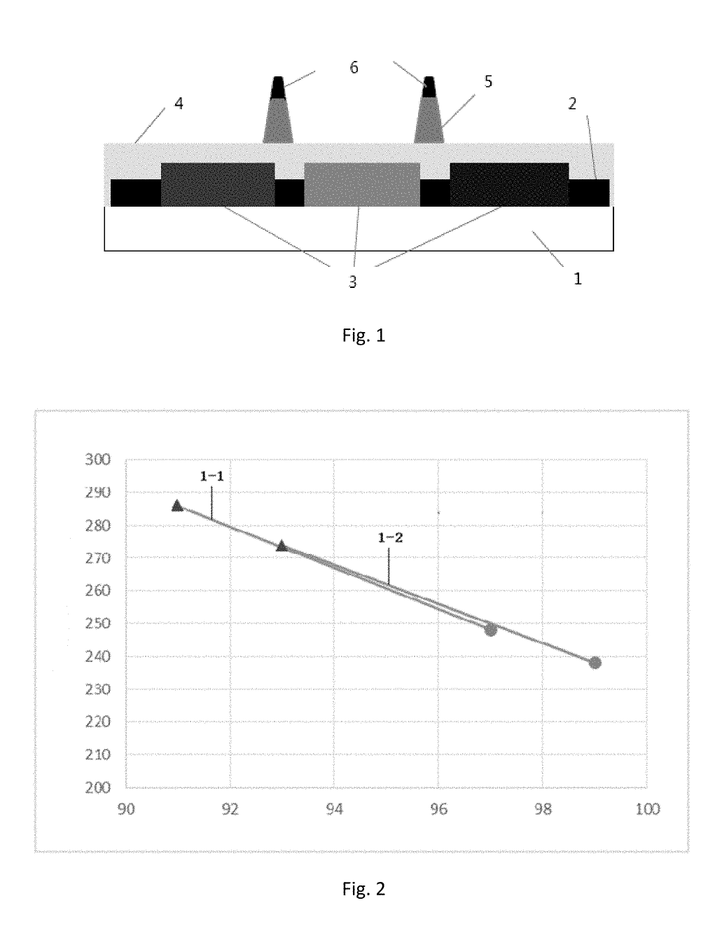

Referring to FIG. 1, a schematic structure view for the color filter substrate according to an embodiment of the present disclosure is shown. Specifically, the color filter substrate can comprise: a patterned black matrix layer 2; a matrix of color filter units, e.g., an RGB layer 3; and an overcoating 4 covering the black matrix layer 2 and the RGB layer 3. Furthermore, the overcoating 4 can be formed by a mixture of a binder polymer, a hardener, a multi-functional monomer and a surface active agent, wherein the binder polymer has a relative molecular mass in a range of 4,000-10,000.

In an embodiment of the present disclosure, molecular weight refers to relative molecular mass. According to an embodiments of the persent disclosure, by using a binder polymer with a molecular weight in a range of 4,000-10,000, a hardener, a multi-functional monomer and a surface active agent, the overcoating can be enhanced in hardenability, reduced in hygroscopicity, and improved in surface tension and surface flatness. Thereby, the vacuum arrive time can be reduced, thus reducing the amount of outgas of the overcoating.

Additionally, as shown in FIG. 1, the color filter substrate can further comprise: a solidified layer 6, spacers 5 and a glass substrate 1.

Optionally, the overcoating 4 can have a thickness of 1.3-1.5 μm.

In actual applications, the amount of outgas of the overcoating will drop as the overcoating decreases in thickness. In this case, it is usually necessary to guarantee fluidity of the overcoating and color difference thereof. Therefore, in an embodiment of the present disclosure, the thickness of the overcoating is set to be 1.3-1.5 μm, which guarantees fluidity of the overcoating and color difference thereof, while ensuring that the amount of outgas of the overcoating is reduced.

In actual applications, hardenability reflects the degree of crosslinking reaction between materials. Specifically, a higher hardenability indicates a more thorough molecular polymerization reaction inside the materials. As can be seen, the higher the hardenability of the overcoating is, the less gas will be released by the overcoating. Meanwhile, outgas of the black matrix layer and the RGB layer at the bottom of the overcoating can be effectively blocked.

Influences of the hardenability of the overcoating on the amount of outgas will be explained below in combination with experimental data. Specifically, FIG. 2 is a schematic view illustrating a change trend for the vacuum arrive time before and after hardenability of the overcoating in the color filter substrate is improved according to an embodiment of the present disclosure.

As shown in FIG. 2, the horizontal axis indicates hardenability (unit: %), and the vertical axis indicates the vacuum arrive time of the overcoating materials (unit: s). The experimental environment for this test is as follows: the thickness of the overcoating is 1.5 μm; the condition for a pre-drying is 90° C./60 s (i.e., the pre-drying is performed at a temperature of 90° C. for 60 s, the same applies hereinafter); the condition for a subsequent drying is 230° C./25 min; the condition for an annealing process is 230° C./60 min; the measurement mode is a transmissive mode; and the measurement range is 600 cm-4,000 cm. In FIG. 2, line 1-1 indicates changes in hardenability after the materials are dried, and line 1-2 indicates changes in hardenability after the materials are annealed. As can be known from comparison between the two triangular signs or circular signs in FIG. 2, the annealing process can improve the hardenability of the overcoating materials by 2%. That is, the hardenability of the overcoating is improved by 2%. When the hardenability of the overcoating is improved by 2%, the vacuum arrive time can be reduced by about 12 s. Meanwhile, by using a binder polymer with a low molecular weight and a highly reactive hardener, the hardenability of the overcoating materials can be effectively improved by about 6%, and thereby the vacuum arrive time can be reduced by about 40 s.

Therefore, in an embodiment of the present disclosure, a binder polymer with a molecular weight of 4,000-10,000 is used together with a hardener to improve the hardenability of the overcoating, and thus reduce the amount of outgas of the overcoating.

As an example, the binder polymer can be an epoxy acrylate polymer. Obviously, the example is only used for a better understanding of the technical solutions in embodiments of the present disclosure. During actual productions, other suitable materials can be adopted, which will not be limited at all in embodiments of the present disclosure.

Optionally, the hardener is an acid anhydride hardener.

In an embodiment of the present disclosure, the acid anhydride hardener is highly reactive, which can effectively enhance the hardenability of the overcoating. The acid anhydride hardener can comprise any one of a carboxyl compound, a hydroxyl compound, an alicyclic compound and an aromatic compound. Obviously, the present disclosure is not limited thereto, and any type of acid anhydride hardener capable of enhancing the hardenability of the overcoating can be adopted. The examples herein are only used for helping to understand technical solutions of the present disclosure more clearly, and cannot be construed as unique limitations to the present disclosure.

In an embodiment of the present disclosure, hygroscopicity refers to the capability for absorbing and releasing, for instance, H₂O and CO₂ in the air by a certain material. In actual applications, for the overcoating materials, the lower the capability for absorbing and releasing H₂O and CO₂ is, or the sooner the releasing speed of gases is, the shorter the vacuum arrive time is. According to an embodiment of the present disclosure, by setting the percentage of acidic substances in the binder polymer to be 5%-15% by mass, and using a hardener further to enhance the hardenability of the overcoating, hygroscopicity at the surface of the overcoating can be improved and the goal of reducing the vacuum arrive time can be achieved.

In an embodiment of the present disclosure, the acidic substances in the binder polymer can comprise an organic acid, an inorganic acid, a phenol and so on. For example, the organic acid can be a carboxylic acid, a sulfonic acid or the like, and the inorganic acid can be an oxo acid, a hydrogen acid, a complex acid, a mixed acid or the like, and the phenol can be oxybenzene or the like.

It can be understood that the acidic substances in the binder polymer as listed above as only examples are used for schematically explaining embodiments of the present disclosure. Obviously, other suitable acidic substances can also be adopted, which will not be limited at all in embodiments of the present disclosure.

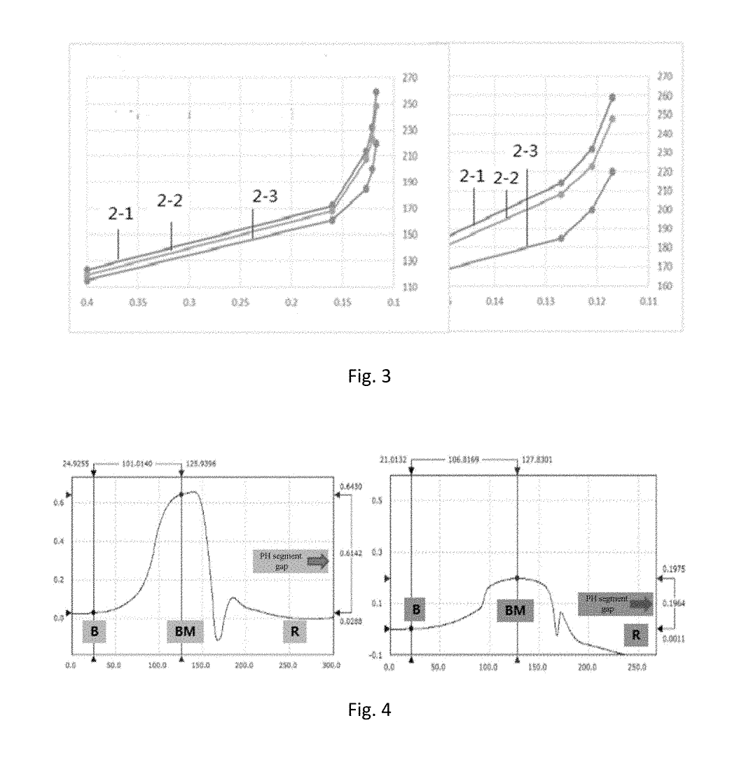

Influences of the hygroscopicity of the overcoating on the amount of outgas will be explained in detail in combination with experimental data. Specifically, FIG. 3 is a schematic view illustrating a change trend for the vacuum arrive time before and after hygroscopicity of the overcoating in the color filter substrate is improved according to an embodiment of the present disclosure.

As shown in FIG. 3, the horizontal axis indicates hardenability (unit: pa), and the vertical axis indicates the vacuum arrive time for the overcoating materials (unit: s). In FIG. 3, the overcoating is a glass substrate, wherein line 2-1 indicates a trend for the vacuum arrive time of the unimproved glass substrate that varies with pressure, and line 2-2 indicates a trend for the vacuum arrive time of the bare glass substrate that varies with pressure, and line 2-3 indicates a trend for the improved vacuum arrive time of the glass substrate that varies with pressure. The method of this test mainly comprises steps as follows:

Step S1: setting the thickness of the overcoating to be 1.5 μm, i.e., setting the thickness of the glass substrate to be 1.5 μm;

Step S2: setting the condition for the pre-drying to be 90° C./60 s, and the condition for the subsequent drying to be 230° C./25 min;

Step S3: soaking the glass substrate for 24 hours, then taking it out and drying it with nitrogen; and

Step S4: recording an air exhaust time for arriving at a set vacuum degree since the air exhaust starts.

As can be seen from analysis, the bare glass substrate has the shortest vacuum arrive time. This proves validity of the test method. Besides, after the hygroscopicity is improved, the vacuum arrive time is reduced by about 10 s under the same condition.

Next, influences of surface flatness of the overcoating (e.g., a glass substrate) and surface tension thereof on the vacuum arrive time of the overcoating materials will be analyzed.

Specifically, the test method mainly comprises steps as follows:

Step S1′: setting the thickness of the overcoating to be 1.5 μm, i.e., setting the thickness of the glass substrate to be 1.5 μm;

Step S2′: setting the condition for the pre-drying to be 90° C./60 s, and the condition for the subsequent drying to be 230° C./25 min;

Step S3′: performing a split test with different UV energies (0 and 200mj); and

Step S4′: calculating a surface tension of the overcoating.

After analysis, the change trend for the surface flatness of the glass substrate before and after the improvement can be shown below in table 2, wherein relevant test results are given.

TABLE 2

| | EUV | Contact Angle (°) | | Surface Energy (mN/m) | | |
|---|---|---|---|---|---|---|
| ITEM | (mj/cm2) | Water | Formamide | γₛ^{d} | γₛ^{P} | γₛ |
| Before | 0 | 67 | 60 | 15 | 21 | 36 |
| improve- | 200 | 35 | 19 | 22 | 39 | 61. |
| ment | | | | | | |
| After | 0 | 62 | 54 | 18 | 22 | 40 |
| improve- | 200 | 31 | 5 | 24 | 40 | 64 |
| ment | | | | | | |

As can be seen from table 2, after the improvement, γs is increased no matter whether the EUV Energy is 0 or 200mj. However, previous experience has told us that the higher the surface tension of the overcoating is, the poorer the surface flatness is. Therefore, for the design of surface tension, higher does not mean better.

In an embodiment of the present disclosure, the optimization of flatness and the promotion of surface tension can improve the vacuum keep time. As can be known from FIG. 2, the improved materials do not require a vacuum keep time, while the vacuum keep time for the unimproved materials can reach 15-18 s.

Optionally, the surface active agent is formed by a mixture of a silicon-based material and a fluorine-based material.

From the above experimental data, in an embodiment of the present disclosure, by using a surface active agent formed by a mixture of a silicon-based material and a fluorine-based material, and setting the percentage of the surface active agent to be less than 1% by mass in the overcoating after being dried, the surface tension of the overcoating materials can be improved and the vacuum keep time can be reduced.

Furthermore, the silicon-based material can comprise high temperature vulcanized silicone rubber, liquid silicone rubber, silicone and so on. The fluorine-based material can comprise FEP, polytrifluoroethylene and so on.

It can be understood that the optional materials for the silicon-based material and the fluorine-based material listed above as examples are only provided for schematically explaining embodiments of the present disclosure. Obviously, other suitable silicon-based materials and fluorine-based materials can also be adopted, which will not be limited at all in embodiments of the present disclosure.

Optionally, the acidic substances in the binder polymer have a percentage ranging from 5% to 15% by mass. In an embodiment of the present disclosure, by decreasing the mass percentage of the acidic substances in the binder polymer, the hygroscopicity of the overcoating can be reduced, and thus the goal of reducing the vacuum keep time can be achieved.

Besides, in actual applications, the main function of the overcoating materials is to reduce an RGB segment gap on a surface of the color filter units, thereby planarizing the color filter units. Besides, this also has great influences on Tact Time.

Influences of the surface flatness of the overcoating on the Tact Time will be explained below in connection with experimental data. Specifically, FIG. 4 is a schematic view illustrating changes in a PH segment gap between a black matrix and an RGB layer before and after surface flatness of the overcoating in the color filter substrate is improved according to an embodiment of the present disclosure. As shown in FIG. 4, after improvement, the PH segment gap between the black matrix and the RGB layer drops from 0.614 μm to 0.196 μm, and the surface flatness of the overcoating is effectively improved. Besides, it can also be seen from FIG. 4, the lower the PH segment gap between the black matrix and the RGB layer is, the better the surface flatness of the overcoating materials is. Therefore, during the ODF process, the faster the liquid crystals diffuse, the shorter the vacuum keep time will be.

In an embodiment of the present disclosure, by using a binder polymer with a low molecular weight and a multi-functional monomer, the surface fluidity of the overcoating materials can be promoted, the surface flatness of the overcoating can be improved, and thus the goal of reducing the vacuum keep time of the overcoating can be achieved. Thereby, the amount of outgas of the overcoating can be reduced.

Optionally, after being dried, the multi-functional monomer has a percentage ranging from 10% to 60% by mass in the overcoating.

In an embodiment of the present disclosure, by using a binder polymer with a molecular weight of 4,000-10,000 and a multi-functional monomer, the surface flatness of the overcoating can be improved. Specifically, after being dried, the multi-functional monomer has a percentage ranging from 10% to 60% by mass in the overcoating.

Correspondingly, in an embodiment of the present disclosure, the multi-functional monomer can comprise an acryloyl-based multi-functional monomer, an epoxy-based multi-functional monomer or the like.

Optionally, after being dried, the binder polymer has a percentage ranging from 15% to 80% by mass in the overcoating.

Optionally, after being dried, the hardener has a percentage ranging from 2% to 15% by mass in the overcoating.

In an embodiment of the present disclosure, in combination with various experimental data, the percentage of the binder polymer is set to be 15%˜80% by mass in the overcoating after being dried, and the percentage of the hardener is set to be 2%˜15% by mass in the overcoating after being dried. In this way, the hardenability of the overcoating is enhanced, the hygroscopicity thereof is reduced, the surface flatness thereof is optimized, and the surface tension thereof is promoted. Thus, the amount of outgas thereof can be better reduced. In addition, for specific experimental data, no detailed depictions will be given herein.

Embodiments of the present disclosure provide a color filter substrate. Specifically, the overcoating comprises a binder polymer, a hardener, a multi-functional monomer and a surface active agent, wherein the binder polymer has a molecular weight of 4,000-10,000. In this way, the hardenability of the overcoating is enhanced, the hygroscopicity thereof is reduced, the surface flatness thereof is optimized and the surface tension thereof is promoted. Thus, the amount of outgas thereof can be reduced. Therefore, the goal of reducing the ODF Tact time and promoting the factory capacity is further achieved.

In addition, an embodiment of the present disclosure further provides a display device. Specifically, the display device can comprise the color filter substrate as described in any of the above embodiments.

For descriptive simplicity, several embodiments are expressed herein as a combination of a series of actions. However, those skilled in the art should know that the present disclosure is not limited by the sequence of the actions described herein, because some of the steps can be carried out simultaneously or in other sequences according to the present disclosure. Moreover, those skilled in the art should also know that the embodiments as described in the description are all optional embodiments, and actions and modules involves therein are not necessarily indispensable in the present disclosure. Each embodiment of the description is described in a progressive manner. Specifically, what each embodiment emphasizes is a difference of the embodiment from the others, and for the same or similar portions between various embodiments, they can refer to each other.

Finally, it should be noted that relational terms such as “first” and “second” are only used for distinguishing one entity or operation from another entity or operation, and they do not necessarily require or imply the presence of any of such actual relations or sequences between the entities or operations. Besides, terms of “comprise”, “include” or any other variants are intended to cover non-exclusive inclusion. In this way, it can be understood that a process, a method, a commodity or a device comprising a series of elements not only comprises the elements, but also comprises other elements not listed explicitly. Alternatively, it can further comprise elements inherent for the process, the method, the commodity or the device. Without more limitations, an element defined by wording “comprising one” does not exclude the presence of further same elements in the process, the method, the commodity or the device comprising the element.

The color filter substrate and the display device as provided in the present disclosure have been introduced in detail. Principles and implementations of the present disclosure are expounded herein by using specific examples. The explanations of these embodiments are only used for helping to understand the method of the present disclosure and the core concept thereof. Meanwhile, a person having ordinary skills in the art can modify the specific implementations and application scopes according to the idea of the present disclosure. In conclusion, the content of the description should not be construed as limiting the present disclosure.

We claim:

1. A color filter substrate, comprising:
a plurality of color filter units arranged in a matrix;
a patterned black matrix layer, the patterned black matrix layer filling gaps between adjacent color filter units; and
an overcoating covering the plurality of color filter units and the patterned black matrix layer, wherein
the overcoating is formed by a mixture of a binder polymer, a hardener, a multi-functional monomer and a surface active agent, and
the binder polymer has a relative molecular mass in a range of 4,000-100,000.

2. The color filter substrate according to claim 1, wherein
the overcoating has a thickness in a range of 1.3-1.5 μm.

3. The color filter substrate according to claim 1, wherein
acidic substances in the binder polymer have a percentage ranging from 5% to 15% by mass.

4. The color filter substrate according to claim 1, wherein
the binder polymer comprises an epoxy acrylate polymer.

5. The color filter substrate according to claim 1, wherein
after being dried, the multi-functional monomer has a percentage ranging from 10% to 60% by mass in the overcoating.

6. The color filter substrate according to claim 5, wherein
the multi-functional monomer comprises an acryloyl-based multi-functional monomer or an epoxy-based multi-functional monomer.

7. The color filter substrate according to claim 1, wherein
the surface active agent is formed by a mixture of a silicon-based material and a fluorine-based material.

8. The color filter substrate according to claim 7, wherein
after being dried, the surface active agent has a percentage less than 1% by mass in the overcoating.

9. The color filter substrate according to claim 1, wherein
after being dried, the binder polymer has a percentage ranging from 15% to 80% by mass in the overcoating.

10. The color filter substrate according to claim 1, wherein
after being dried, the hardener has a percentage ranging from 2% to 15% by mass in the overcoating.

11. The color filter substrate according to claim 1, wherein
the hardener comprises an acid anhydride hardener.

12. The color filter substrate according to claim 11, wherein
the acid anhydride hardener comprises any one of a carboxyl compound, a hydroxyl compound, an alicyclic compound and an aromatic compound.

13. A display device, comprising the color filter substrate according to claim 1.

14. The display device according to claim 13, wherein
the overcoating has a thickness in a range of 1.3-1.5 μm.

15. The display device according to claim 13, wherein
acidic substances in the binder polymer have a percentage ranging from 5% to 15% by mass.

16. The display device according to claim 13, wherein
the binder polymer comprises an epoxy acrylate polymer.

17. The display device according to claim 13, wherein
after being dried, the multi-functional monomer has a percentage ranging from 10% to 60% by mass in the overcoating.

18. The display device according to claim 13, wherein
the surface active agent is formed by a mixture of a silicon-based material and a fluorine-based material.

19. The display device according to claim 13, wherein
after being dried, the binder polymer has a percentage ranging from 15% to 80% by mass in the overcoating.

20. The display device according to claim 13, wherein
after being dried, the hardener has a percentage ranging from 2% to 15% by mass in the overcoating.
